(19) United States
(12) Patent Application Publication
(10) Pub. No.: US 2026/0194850 A1
(43) Pub. Date: Jul. 9, 2026

(54) IMAGE FORMING APPARATUS CAPABLE OF CONTROLLING AMOUNT OF DEFLECTION OF SHEET CONVEYED BY BOTH TRANSFER PORTION AND FIXING PART AND OPERATION CONTROL METHOD

(71) Applicant: KYOCERA Document Solutions Inc., Osaka (JP)

(72) Inventor: Yoshiyuki Odaka, Osaka (JP)

(21) Appl. No.: 19/439,050

(22) Filed: Jan. 2, 2026

(30) Foreign Application Priority Data
Jan. 8, 2025 (JP) 2025-002693

(51) Int. Cl. G03G 15/00

(52) U.S. Cl. CPC G03G 15/657; G03G 15/6564; G03G 2215/00409; G03G 2215/00413; G03G 2215/00616; G03G 2215/00679; G03G 2215/00721

(57) ABSTRACT

An image forming apparatus includes a transfer portion, a fixing part, a first detection processing portion, and an adjustment processing portion. The transfer portion transfers a toner image to a sheet. The fixing part fixes the toner image transferred to the sheet onto the sheet. The fixing part is provided on a downstream side in a conveyance path of the sheet with respect to a conveyance direction of the sheet. The conveyance path extends through the transfer portion. The first detection processing portion detects an amount of deflection of the sheet during a specific period in which the sheet is conveyed by both the transfer portion and the fixing part. The adjustment processing portion adjusts, before the specific period ends, conveyance speed of the sheet by the fixing part on the basis of the amount of deflection detected during the specific period.

### INCORPORATION BY REFERENCE

This application is based upon and claims the benefit of priority from the corresponding Japanese Patent Application No. 2025-002693 filed on January 8, 2025, the entire contents of which are incorporated herein by reference.

### BACKGROUND

This disclosure relates to an image forming apparatus and an operation control method.

An electrophotographic image forming apparatus includes a transfer portion and a fixing part. The transfer portion transfers a toner image to a sheet and conveys the sheet. The fixing part fixes the toner image transferred to the sheet onto the sheet and conveys the sheet.

In addition, to control the amount of deflection of the sheet conveyed by both the transfer portion and the fixing part, the image forming apparatus that adjusts, on the basis of a result obtained by detecting the amount of deflection of the sheet that is first conveyed during an image forming operation, the conveyance speed of the second or subsequent sheet by the fixing part has been known as the related art.

### SUMMARY

An image forming apparatus according to an aspect of this disclosure includes a transfer portion, a fixing part, a first detection processing portion, and an adjustment processing portion. The transfer portion transfers a toner image to a sheet and conveys the sheet. The fixing part fixes the toner image transferred to the sheet onto the sheet and conveys the sheet. The fixing part is provided on a downstream side in a conveyance path of the sheet with respect to a conveyance direction of the sheet. The conveyance path extends through the transfer portion. The first detection processing portion detects an amount of deflection of the sheet during a specific period in which the sheet is conveyed by both the transfer portion and the fixing part. The adjustment processing portion adjusts, before the specific period ends, conveyance speed of the sheet by any one or both of the transfer portion and the fixing part on the basis of the amount of deflection detected during the specific period.

An operation control method according to another aspect of this disclosure is executed by an image forming apparatus including a transfer portion and a fixing part. The transfer portion transfers a toner image to a sheet and conveys the sheet. The fixing part fixes the toner image transferred to the sheet onto the sheet and conveys the sheet. The fixing part is provided on a downstream side in a conveyance path of the sheet with respect to a conveyance direction of the sheet. The conveyance path extends through the transfer portion. The operation control method includes a detection step and an adjustment step. In the detection step, an amount of deflection of the sheet is detected during a specific period in which the sheet is conveyed by both the transfer portion and the fixing part. In the adjustment step, before the specific period ends, conveyance speed of the sheet by any one or both of the transfer portion and the fixing part is adjusted on the basis of the amount of deflection detected during the specific period.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view of a configuration of an image forming apparatus according to an embodiment of this disclosure.

FIG. 2 is a block diagram showing a system configuration of the image forming apparatus according to the embodiment of this disclosure.

FIG. 3 is a cross-sectional view of a configuration of an image forming portion of the image forming apparatus according to the embodiment of this disclosure.

FIG. 4 is a cross-sectional view of a configuration near a transfer nip portion and a fixing nip portion of the image forming apparatus according to the embodiment of this disclosure.

FIG. 5 is a flowchart showing an example of an operation control process that is executed by the image forming apparatus according to the embodiment of this disclosure.

### DETAILED DESCRIPTION

Hereinafter, an embodiment of this disclosure will be described with reference to the accompanying drawings. It is noted that the following embodiment is a specific example of this disclosure and does not limit the technical scope of this disclosure.

### Configuration of Image Forming Apparatus 100

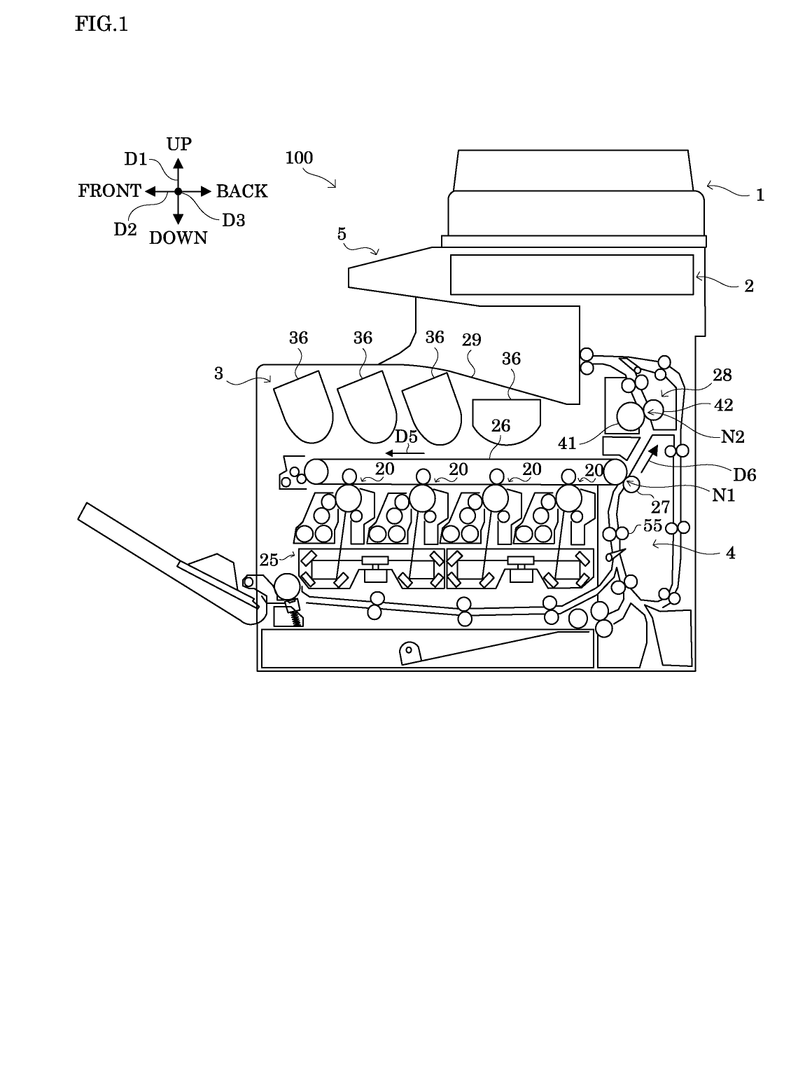

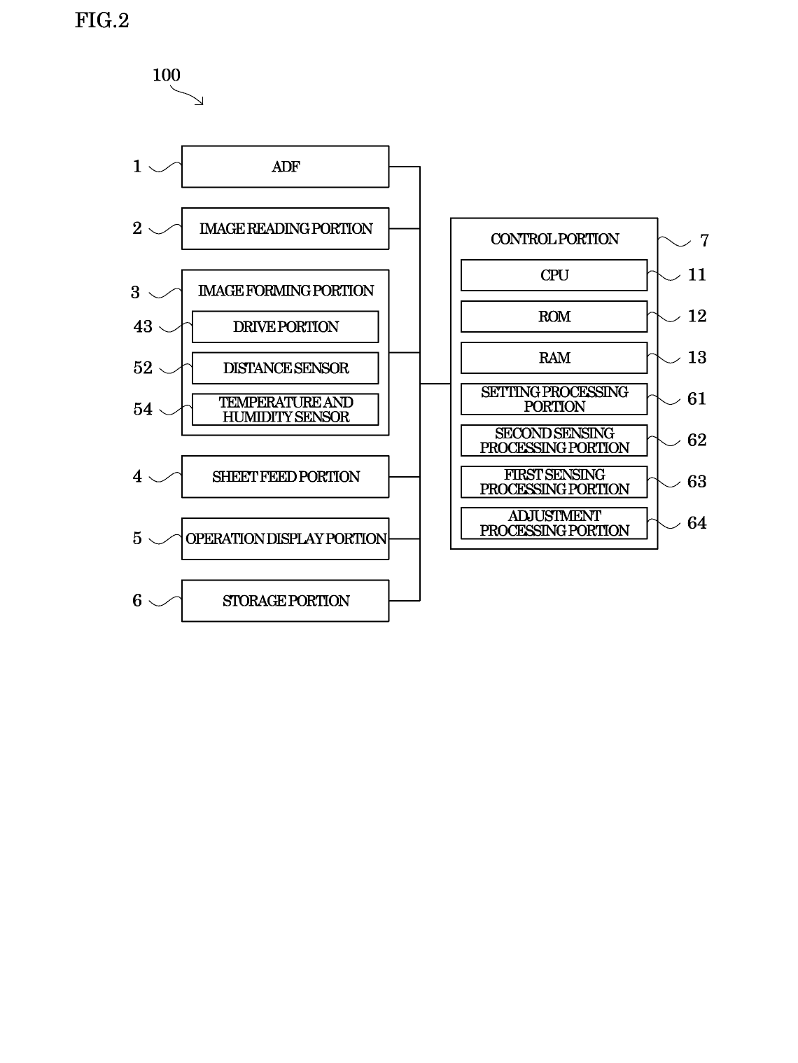

First, the configuration of an image forming apparatus 100 according to the embodiment of this disclosure will be described with reference to FIGS. 1 and 2.

It is noted that the perpendicular direction viewed with the image forming apparatus 100 placed in an installation state (state shown in FIG. 1) that allows the image forming apparatus 100 to be used is defined as an up-down direction D1 for the convenience of description. In addition, a front-back direction D2 is defined using the surface of the image forming apparatus 100 shown in FIG. 1 corresponding to the left of FIG. 1 as a front (front surface). Furthermore, a left-right direction D3 is defined on the basis of the front of the image forming apparatus 100 in the installation state.

The image forming apparatus 100 is a multifunction peripheral having a plurality of functions such as a facsimile function and a copy function along with a scan function of reading an image on a document sheet and a print function of forming an image on a sheet on the basis of image data. It is noted that this disclosure may be applied to an image forming apparatus such as a printer, a facsimile apparatus, and a copier.

As shown in FIGS. 1 and 2, the image forming apparatus 100 includes an auto document feeder (ADF) 1, an image reading portion 2, an image forming portion 3, a sheet feed portion 4, an operation display portion 5, a storage portion 6, and a control portion 7.

The ADF 1 conveys a document sheet to be read by the scan function. The ADF 1 includes a document sheet set portion, a plurality of conveying rollers, a document sheet holder, and a sheet discharge portion.

The image reading portion 2 achieves the scan function. The image reading portion 2 includes a document sheet table, a light source, a plurality of mirrors, an optical lens, and a charge coupled device (CCD).

The image forming portion 3 achieves the print function. Specifically, the image forming portion 3 forms a color or monochrome image on a sheet supplied from the sheet feed portion 4 in accordance with electrophotography.

The sheet feed portion 4 supplies a sheet to the image forming portion 3. The sheet feed portion 4 includes a sheet feed cassette, a manual feed tray, and a plurality of conveying rollers.

The operation display portion 5 is a user interface of the image forming apparatus 100. The operation display portion 5 includes a display portion and an operation portion. The display portion displays various kinds of information in response to a control instruction from the control portion 7. For example, the display portion is a display device such as a liquid-crystal display. The operation portion inputs various kinds of information to the control portion 7 in response to an operation of a user. For example, the operation portion is an operation device including an operation key and a touch panel.

The storage portion 6 is a non-volatile storage device. For example, the storage portion 6 is a flash memory.

The control portion 7 integrally controls the image forming apparatus 100. As shown in FIG. 2, the control portion 7 includes a CPU 11, a ROM 12, and a RAM 13. The CPU 11 is a processor that executes various calculation processes. The ROM 12 is a non-volatile storage device that stores in advance information about a control program or the like for causing the CPU 11 to execute various processes. The RAM 13 is a volatile or non-volatile storage device that is used as a temporary storage memory (work area) for various processes which are executed by the CPU 11. The CPU 11 integrally controls the image forming apparatus 100 by executing various control programs stored in advance in the ROM 12.

It is noted that the control portion 7 may be a control portion provided separately from a main control portion which integrally controls the image forming apparatus 100. In addition, the control portion 7 may be composed of an electronic circuit such as an integrated circuit (ASIC).

### Configuration of Image Forming Portion 3

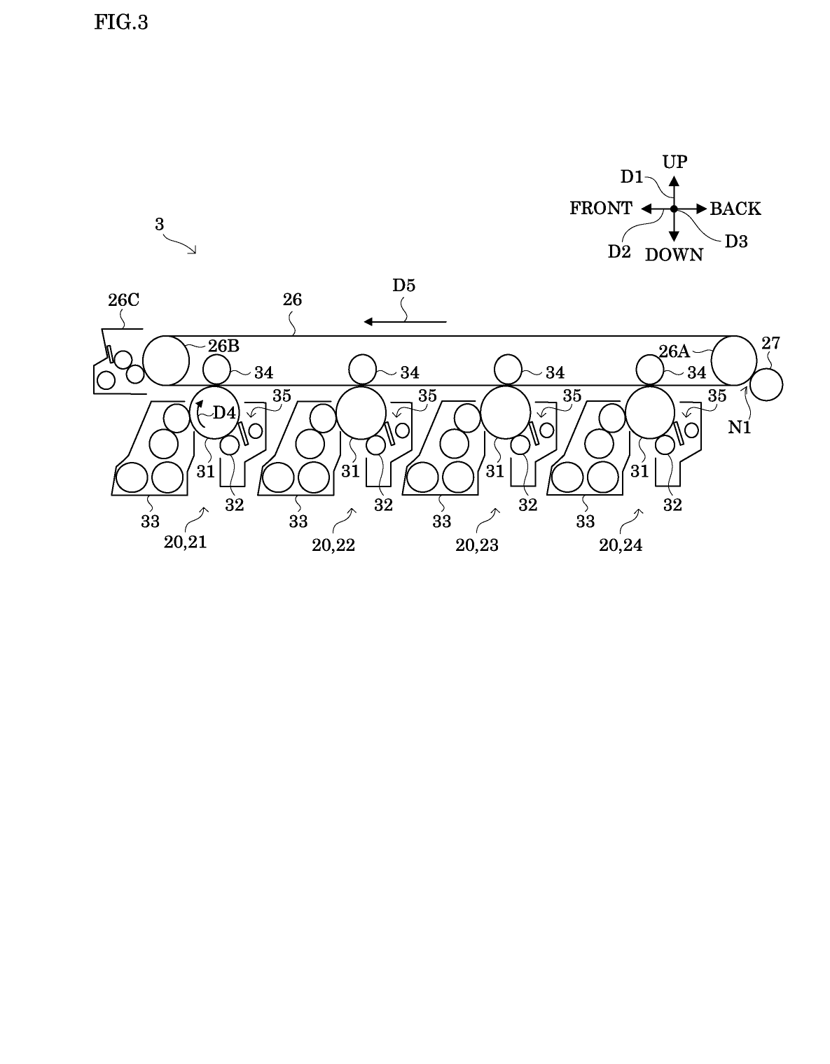

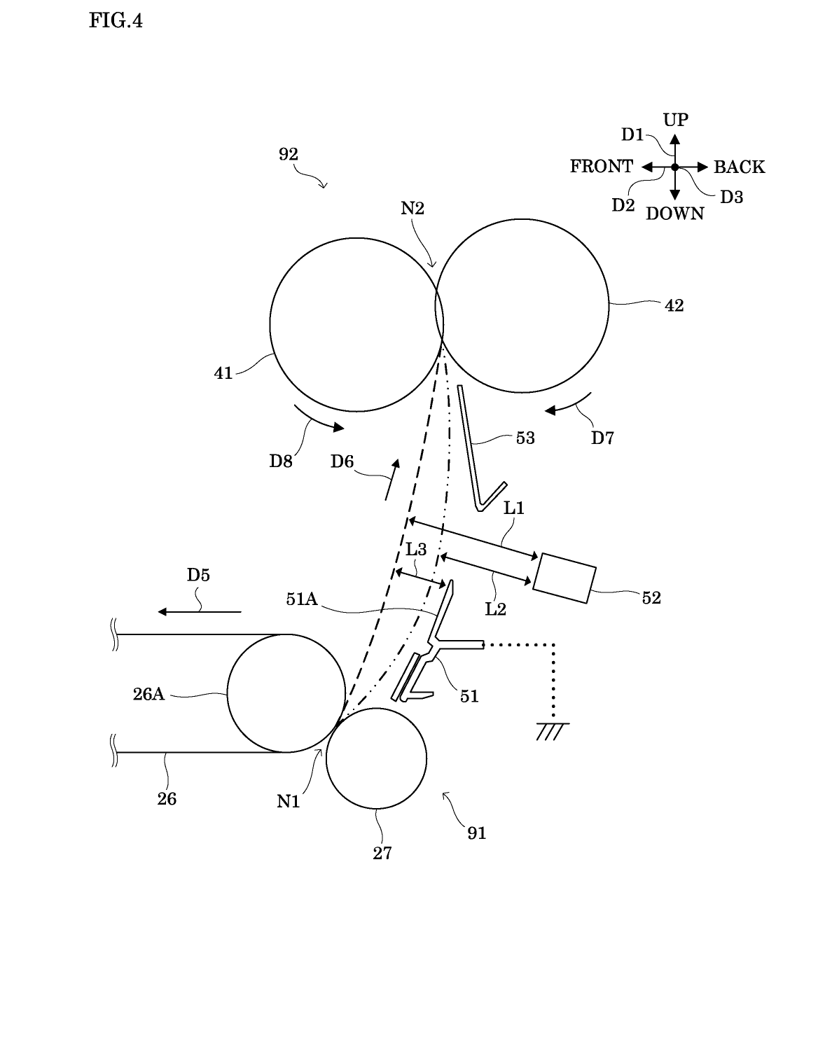

Next, the configuration of the image forming portion 3 will be described with reference to FIGS. 1 to 4. Here, FIG. 3 is a cross-sectional view of the configurations of a plurality of image forming units 20, an intermediate transfer belt 26, and a secondary transfer roller 27. It is noted that FIG. 4 shows an undeflected (the amount of deflection is zero) sheet using a dashed line. In addition, FIG. 4 shows a deflected sheet using a two-dot chain line. Furthermore, FIG. 4 shows an electrical conduction path between a first guide member 51 and the ground using a dotted line.

As shown in FIG. 1, the image forming portion 3 includes the four image forming units 20, a laser scanning unit 25, the intermediate transfer belt 26, the secondary transfer roller 27, a fixing device 28, and a sheet discharge tray 29. In addition, as shown in FIGS. 2 and 4, the image forming portion 3 includes the first guide member 51, a distance sensor 52, a second guide member 53, and a temperature and humidity sensor 54.

Of the four image forming units 20, an image forming unit 21 (see FIG. 3) forms a toner image of Y (yellow). Of the four image forming units 20, an image forming unit 22 (see FIG. 3) forms a toner image of C (cyan). Of the four image forming units 20, an image forming unit 23 (see FIG. 3) forms a toner image of M (magenta). Of the four image forming units 20, an image forming unit 24 (see FIG. 3) forms a toner image of K (black). That is, the image forming portion 3 forms an image on a sheet using the respective toners of C, M, Y, and K. As shown in FIGS. 1 and 3, the four image forming units 20 are provided side by side along the front-back direction D2 in the order of yellow, cyan, magenta, and black from the front side of the image forming apparatus 100.

As shown in FIG. 3, each of the image forming units 20 includes a photoconductor drum 31, a charging roller 32, a developing device 33, a primary transfer roller 34, and a drum cleaning portion 35. In addition, each of the image forming units 20 includes a toner container 36 shown in FIG. 1.

An electrostatic latent image is formed on the surface of the photoconductor drum 31. For example, the photoconductor drum 31 includes a photosensitive layer formed using amorphous silicon. The photoconductor drum 31 rotates in a rotation direction D4 shown in FIG. 3 upon receiving rotational driving force supplied from an unillustrated motor. This causes the photoconductor drum 31 to convey the electrostatic latent image formed on the surface.

The charging roller 32 charges the surface of the photoconductor drum 31 upon receiving the application of a charging voltage set in advance. For example, the charging roller 32 positively charges the surface of the photoconductor drum 31. The surface of the photoconductor drum 31 charged by the charging roller 32 is irradiated with light emitted from the laser scanning unit 25 and based on image data. This forms an electrostatic latent image on the surface of the photoconductor drum 31.

The developing device 33 develops the electrostatic latent image formed on the surface of the photoconductor drum 31. The developing device 33 includes a pair of stirring members, a magnet roller, and a developing roller. The pair of stirring members stirs a developer stored inside the developing device 33. The developer includes toner and carriers. This positively charges the toner included in the developer because of the friction with the carriers included in the developer. The magnet roller draws up the developer stirred by the pair of stirring members and supplies the toner included in the developer to the developing roller. The developing roller conveys the toner supplied from the magnet roller to the position opposed to the photoconductor drum 31. In addition, the developing roller supplies the photoconductor drum 31 with the toner conveyed to the opposed position upon receiving the application of a developing bias voltage set in advance. This visualizes (develops) the electrostatic latent image formed on the surface of the photoconductor drum 31. It is noted that the developing device 33 is supplied with the toner from the toner container 36.

The primary transfer roller 34 transfers a toner image formed on the surface of the photoconductor drum 31 to the outer peripheral surface of the intermediate transfer belt 26 upon receiving the supply of a primary transfer current set in advance. As shown in FIG. 3, the primary transfer roller 34 is provided to face the photoconductor drum 31 across the intermediate transfer belt 26.

The drum cleaning portion 35 removes the toner remaining on the surface of the photoconductor drum 31 after the primary transfer roller 34 transfers the toner image.

The laser scanning unit 25 emits the light based on the image data toward the surface of the photoconductor drum 31 of each of the image forming units 20.

The intermediate transfer belt 26 is an endless belt member to which the toner image formed on the surface of the photoconductor drum 31 of each of the image forming units 20 is transferred. The intermediate transfer belt 26 is stretched under predetermined tension by a drive roller 26A (see FIG. 3) and a stretching roller 26B (see FIG. 3). The drive roller 26A rotates upon receiving rotational driving force supplied from an unillustrated motor, thereby rotating the intermediate transfer belt 26 in a rotation direction D5 shown in FIG. 3. This causes the intermediate transfer belt 26 to convey the toner image formed on the outer peripheral surface to a transfer nip portion N1 (see FIG. 3) formed between the intermediate transfer belt 26 and the secondary transfer roller 27. It is noted that the outer peripheral surface of the intermediate transfer belt 26 after the secondary transfer roller 27 transfers the toner image is cleaned by a belt cleaning device 26C shown in FIG. 3.

The secondary transfer roller 27 transfers the toner image transferred to the outer peripheral surface of the intermediate transfer belt 26 to a sheet supplied from the sheet feed portion 4 upon receiving the supply of a secondary transfer current set in advance. As shown in FIG. 3, the secondary transfer roller 27 is provided to face the drive roller 26A across the intermediate transfer belt 26. The secondary transfer roller 27 is biased by an unillustrated biasing member toward the drive roller 26A to come into contact with the intermediate transfer belt 26 at first nip pressure defined in advance. The secondary transfer roller 27 transfers the toner image formed on the intermediate transfer belt 26 to a sheet at the transfer nip portion N1 (see FIG. 3) formed between the secondary transfer roller 27 and the intermediate transfer belt 26. The sheet to which the toner image is transferred at the transfer nip portion N1 is conveyed in a conveyance direction D6 (see FIG. 1) toward a fixing nip portion N2 (see FIG. 1).

The intermediate transfer belt 26 and the secondary transfer roller 27 are included in a transfer portion 91 (see FIG. 4) that transfers a toner image to a sheet and conveys the sheet.

The fixing device 28 fixes the toner image transferred to the sheet by the secondary transfer roller 27 onto the sheet.

As shown in FIGS. 1 and 4, the fixing device 28 includes a fixing roller 41 and a pressure roller 42. In addition, the fixing device 28 includes a drive portion 43 shown in FIG. 2.

The fixing roller 41 is provided so as to be rotatable. The fixing roller 41 comes into contact with a sheet to which a toner image is transferred and fixes the toner image onto the sheet.

The pressure roller 42 is provided so as to be rotatable while facing the fixing roller 41. The pressure roller 42 is biased by an unillustrated biasing member toward the fixing roller 41 to come into contact with the fixing roller 41 at second nip pressure defined in advance. The pressure roller 42 hereby forms the fixing nip portion N2 (see FIGS. 1 and 4) that pressurizes a sheet between the pressure roller 42 and the fixing roller 41.

The drive portion 43 rotates the pressure roller 42 in a rotation direction D7 shown in FIG. 4. The drive portion 43 is a motor.

The pressure roller 42 rotates in the rotation direction D7 upon receiving rotational driving force supplied from the drive portion 43, thereby rotating the fixing roller 41 in a rotation direction D8 shown in FIG. 4 in a driven manner.

There is provided an unillustrated heater inside the fixing roller 41. The heater heats the fixing roller 41 to fixing temperature defined in advance. The fixing roller 41 is heated to the fixing temperature, thereby pressurizing and heating a sheet passing through the fixing nip portion N2. This fixes a toner image transferred to a sheet onto the sheet.

As shown in FIGS. 1 and 4, the fixing roller 41 and the pressure roller 42 are provided on the downstream side in a conveyance path of a sheet with respect to the conveyance direction D6 of a sheet. The conveyance path extends through the transfer portion 91. The fixing roller 41 and the pressure roller 42 are included in a fixing part 92 (see FIG. 4) that fixes a toner image transferred to a sheet onto the sheet and conveys the sheet.

The first guide member 51 guides a sheet between the transfer portion 91 and the fixing part 92 in the conveyance path. The first guide member 51 has a guide surface 51A (see FIG. 4) opposed to the back surface of a sheet.

In addition, the first guide member 51 removes static electricity from a sheet conveyed along the conveyance path. Specifically, the first guide member 51 is formed using a member having electrical conductivity. In addition, as shown in FIG. 4, the first guide member 51 is electrically grounded. The first guide member 51 is an example of a guide member according to this disclosure.

The distance sensor 52 is used to detect the amount of deflection caused in a sheet in a case where the sheet is conveyed by both the transfer portion 91 and the fixing part 92. For example, the distance sensor 52 is a reflective light sensor including a light emitting portion and a light receiving portion. The light emitting portion emits light to the conveyance path. The light receiving portion receives light emitted from the light emitting portion and reflected by a sheet and outputs a detection signal having a voltage corresponding to the amount of received light. It is noted that the distance sensor 52 may be an ultrasonic sensor or the like.

The second guide member 53 guides a sheet entering the fixing nip portion N2 between the first guide member 51 and the fixing nip portion N2 in the conveyance path.

The temperature and humidity sensor 54 detects the temperature and humidity of the installation place of the image forming apparatus 100. For example, the temperature and humidity sensor 54 is provided inside a housing of the image forming apparatus 100. It is noted that the temperature and humidity sensor 54 may be provided outside the housing of the image forming apparatus 100.

Incidentally, to control the amount of deflection of a sheet conveyed by both the transfer portion 91 and the fixing part 92, an image forming apparatus that adjusts, on the basis of a result obtained by detecting the amount of deflection of the sheet that is first conveyed during an image forming operation, the conveyance speed of the second or subsequent sheet by the fixing part 92 has been known as the related art.

It is not, however, possible for the image forming apparatus according to the related art to control the amount of deflection of the sheet that is first conveyed during an image forming operation.

In contrast, it is possible for the image forming apparatus 100 according to the embodiment of this disclosure to control the amount of deflection of a sheet conveyed by both the transfer portion 91 and the fixing part 92 as described below.

### Configuration of Control Portion 7

Next, the configuration of the control portion 7 will be described with reference to FIG. 2.

As shown in FIG. 2, the control portion 7 includes a setting processing portion 61, a second detection processing portion 62, a first detection processing portion 63, and an adjustment processing portion 64.

Specifically, the ROM 12 of the control portion 7 stores an operation control program in advance for causing the CPU 11 to function as each of the processing portions described above. The CPU 11 then functions as each of the processing portions described above by executing the operation control program stored in the ROM 12.

It is noted that the operation control program may be recorded in a computer-readable recording medium such as a CD, a DVD, and a flash memory, and read from the recording medium and stored in a storage device such as the storage portion 6. In addition, some or all of the processing portions included in the control portion 7 may be each composed of an electronic circuit. In addition, the operation control program may be a program for causing a plurality of processors to function as the respective processing portions included in the control portion 7.

The setting processing portion 61 sets, in response to an operation of a user on the operation display portion 5, a sheet on which an image is formed in an image formation process of forming an image on a sheet.

For example, the setting processing portion 61 causes the operation display portion 5 to display a sheet setting screen used to set a sheet in response to an operation of a user on the operation display portion 5. The operation is defined in advance. The sheet setting screen receives a setting operation of setting the size and the type of a sheet. Examples of the type of a sheet include thick paper, plain paper, and thin paper. The setting processing portion 61 sets the type of a sheet in response to the setting operation.

It is noted that the setting operation may be an operation of setting the thickness or the grammage of a sheet.

The second detection processing portion 62 uses the distance sensor 52 to detect that the end of a sheet in the conveyance direction D6 passes a detection position for the amount of deflection of a sheet by the distance sensor 52 in the conveyance path.

For example, in a case where the voltage of the detection signal output from the distance sensor 52 is less than a threshold defined in advance, the second detection processing portion 62 determines that there is no sheet present at the detection position. In addition, in a case where the voltage of the detection signal is greater than or equal to the threshold, the second detection processing portion 62 determines that there is a sheet present at the detection position. The threshold is set on the basis of the voltage of the detection signal corresponding to distance L1 (see FIG. 4) between a sheet conveyed by both the transfer portion 91 and the fixing part 92 and the distance sensor 52 in a case where the amount of deflection of the sheet is zero (see the dashed line in FIG. 4).

In a case where a result of the determination about the presence or absence of a sheet at the detection position is switched, the second detection processing portion 62 then determines that the end of a sheet in the conveyance direction D6 passes the detection position.

In the image forming apparatus 100, the front end of a sheet hits against a registration roller 55 (see FIG. 1) on the upstream side of the transfer nip portion N1 (see FIG. 4) in the conveyance path with respect to the conveyance direction D6, thereby correcting the skew of the sheet. In addition, in the image forming apparatus 100, in a case where the front end of a sheet is not detected by the second detection processing portion 62 before a predetermined time elapses after the conveyance start timing of a sheet by the registration roller 55, the occurrence of a jam (paper jam) is determined.

The first detection processing portion 63 detects the amount of deflection of a sheet during a specific period in which the sheet is conveyed by both the transfer portion 91 and the fixing part 92.

Specifically, the first detection processing portion 63 uses the distance sensor 52 to detect the amount of deflection of a sheet.

For example, in a case where first time based on the conveyance speed of a sheet and the distance from the registration roller 55 to the fixing part 92 in the conveyance path elapses after the conveyance start timing of a sheet by the registration roller 55, the first detection processing portion 63 determines that the specific period starts. In addition, in a case where the total time of the first time and second time based on the conveyance speed of a sheet and the length of a sheet in the conveyance direction D6 elapses after the conveyance start timing of a sheet by the registration roller 55, the first detection processing portion 63 determines that the specific period ends.

For example, the first detection processing portion 63 detects the amount of deflection of a sheet in a detection cycle defined in advance.

For example, the first detection processing portion 63 acquires distance L2 (see FIG. 4) between a sheet and the distance sensor 52 on the basis of the voltage of the detection signal output from the distance sensor 52. The first detection processing portion 63 then acquires the difference between the distance L1 and the distance L2 as the amount of deflection of a sheet.

It is noted that the first time, the second time, and the detection cycle may be set to any values in response to an operation of a user on the operation display portion 5.

In addition, in a case where third time based on the conveyance speed of a sheet and the distance from the detection position to the fixing part 92 in the conveyance path elapses after the timing at which the second detection processing portion 62 detects that the front end of a sheet passes the detection position, the first detection processing portion 63 may determine that the specific period starts. In addition, in a case where the total time of the third time and the second time elapses after the timing at which the second detection processing portion 62 detects that the front end of a sheet passes the detection position, the first detection processing portion 63 may determine that the specific period ends.

Before the specific period ends, the adjustment processing portion 64 adjusts the conveyance speed of a sheet by the fixing part 92 on the basis of the amount of deflection of a sheet detected during the specific period.

For example, whenever the first detection processing portion 63 detects the amount of deflection of a sheet, the adjustment processing portion 64 adjusts the conveyance speed of a sheet by the fixing part 92.

In addition, the adjustment processing portion 64 adjusts the conveyance speed of a sheet by the fixing part 92 to bring the distance between a sheet and the guide surface 51A of the first guide member 51 into agreement with specific distance based on the type of a sheet (an example of an attribute of a sheet according to this disclosure). It is noted that the distance between a sheet and the guide surface 51A of the first guide member 51 is distance obtained by subtracting the amount of deflection of a sheet detected by the first detection processing portion 63 from distance L3 (see FIG. 4) between an undeflected sheet (see the dashed line in FIG. 4) and the guide surface 51A.

For example, in the image forming apparatus 100, the storage portion 6 stores in advance first table data indicating the relationship between the type of a sheet and the specific distance. The first table data defines the relationship between the type of a sheet and the specific distance such that the specific distance is the largest in a case where a sheet is thick paper, and the specific distance is the smallest in a case where a sheet is thin paper. This makes it possible for the first guide member 51 to remove more static electricity from a sheet as the sheet has less thickness. It is therefore possible to restrain a sheet more from having a varying amount of charge in the width direction orthogonal to the conveyance direction D6 as the sheet has less thickness. It is thus possible to prevent a sheet low in stiffness from being twisted (e.g., the end of the sheet in the width direction is curved toward the first guide member 51) by the varying amount of charge of the sheet in the width direction in a case where the sheet is conveyed.

In a case where the image formation process is executed, the adjustment processing portion 64 uses the first table data to acquire the specific distance corresponding to the type of a sheet set by the setting processing portion 61. In addition, the adjustment processing portion 64 calculates, on the basis of the acquired specific distance, the amount of deflection (target amount of deflection) of a sheet that brings the distance between a sheet and the guide surface 51A of the first guide member 51 into agreement with the specific distance. The adjustment processing portion 64 then adjusts the conveyance speed of a sheet by the fixing part 92 on the basis of the amount of deviation between the amount of deflection of a sheet detected by the first detection processing portion 63 and the target amount of deflection. That is, the adjustment processing portion 64 performs feedback control over the drive portion 43 on the basis of the amount of deflection of a sheet detected by the first detection processing portion 63 and the target amount of deflection.

Specifically, in a case where the amount of deflection of a sheet detected by the first detection processing portion 63 is larger than the target amount of deflection, the adjustment processing portion 64 controls the drive portion 43 to increase the conveyance speed of a sheet by the fixing part 92 by a predetermined amount. In addition, in a case where the amount of deflection of a sheet detected by the first detection processing portion 63 is smaller than the target amount of deflection, the adjustment processing portion 64 controls the drive portion 43 to decrease the conveyance speed of a sheet by the fixing part 92 by a predetermined amount. In addition, the adjustment processing portion 64 adjusts the conveyance speed of a sheet by the fixing part 92 within a speed adjustment range defined in advance.

It is noted that the adjustment processing portion 64 may adjust the conveyance speed of a sheet by the fixing part 92 to bring the distance between a sheet and the guide surface 51A of the first guide member 51 into agreement with the specific distance based on the thickness (another example of the attribute of a sheet according to this disclosure) of a sheet or the grammage (another example of the attribute of a sheet according to this disclosure) of a sheet.

In addition, the adjustment processing portion 64 may adjust the conveyance speed of a sheet by the fixing part 92 to bring the distance between a sheet and the guide surface 51A of the first guide member 51 into agreement with fixed distance defined regardless of the attribute of a sheet.

### Operation Control Process

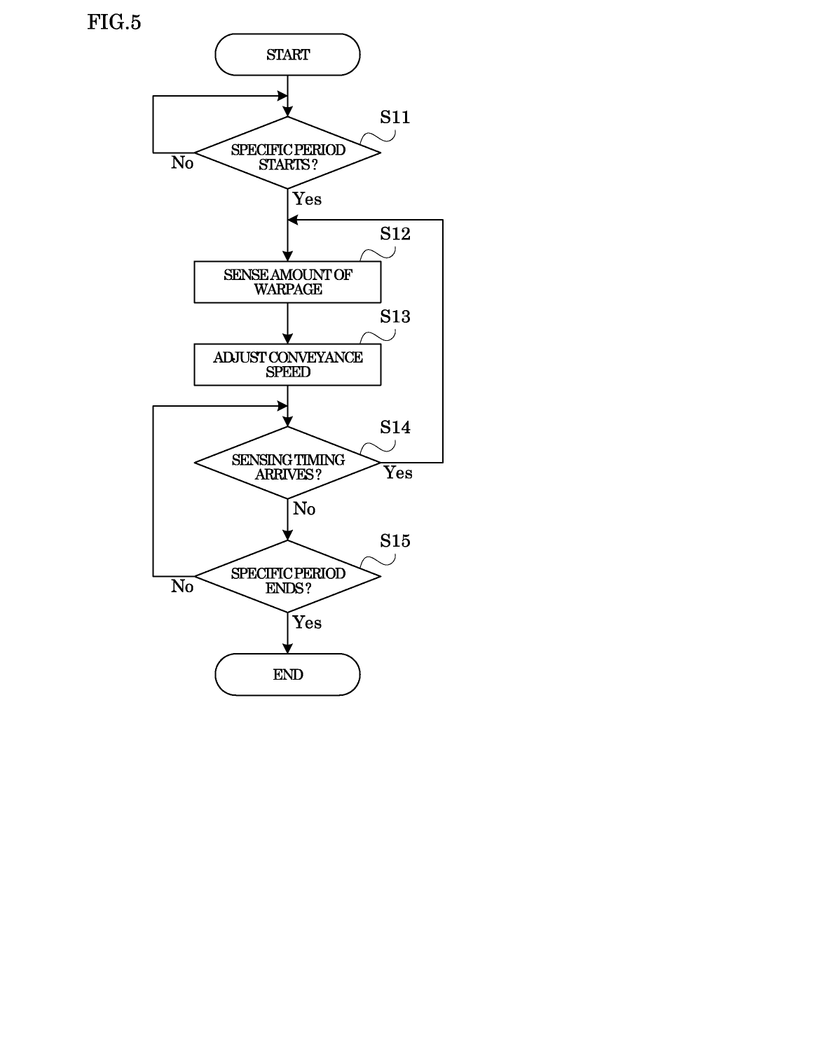

The following describes an operation control method according to this disclosure along with examples of procedures of an operation control process that is executed by the control portion 7 in the image forming apparatus 100 with reference to FIG. 5. Here, steps S11, S12, ... denote the numbers of processing procedures (steps) that are executed by the control portion 7.

It is noted that the control portion 7 executes the operation control process during the image formation process whenever a sheet is conveyed.

In addition, the control portion 7 acquires the target amount of deflection corresponding to the type of a sheet defined in advance when the image formation process starts.

### Step S11

First, in step S11, the control portion 7 determines whether or not the specific period starts.

Specifically, in a case where the first time based on the conveyance speed of a sheet and the distance from the registration roller 55 to the fixing part 92 in the conveyance path elapses after the conveyance start timing of a sheet by the registration roller 55, the control portion 7 determines that the specific period starts.

Here, when the control portion 7 determines that the specific period starts (Yes in S11), the control portion 7 shifts the process to step S12. In addition, if the specific period does not start (No in S11), the control portion 7 waits for the specific period to start in step S11.

### Step S12

In step S12, the control portion 7 detects the amount of deflection of a sheet. The process of step S12 is an example of a detection step according to this disclosure and is executed by the first detection processing portion 63 of the control portion 7.

Specifically, the control portion 7 acquires the distance L2 (see FIG. 4) between a sheet and the distance sensor 52 on the basis of the voltage of the detection signal output from the distance sensor 52. The control portion 7 then acquires the difference between the distance L1 and the distance L2 as the amount of deflection of a sheet.

### Step S13

In step S13, the control portion 7 adjusts the conveyance speed of a sheet by the fixing part 92 on the basis of the last result obtained by detection the amount of deflection through the process of step S12. The process of step S13 is an example of an adjustment step according to this disclosure and is executed by the adjustment processing portion 64 of the control portion 7.

Specifically, the control portion 7 controls the driving of the drive portion 43 to bring the amount of deflection of a sheet detected through the process of step S12 into agreement with the target amount of deflection acquired when the image formation process starts.

### Step S14

In step S14, the control portion 7 determines whether or not the detection timing of the amount of deflection of a sheet arrives.

Specifically, in a case where the time of the detection cycle elapses after the execution of the process of step S12, the control portion 7 determines that the detection timing arrives.

Here, when the control portion 7 determines that the detection timing arrives (Yes in S14), the control portion 7 shifts the process to step S12. In addition, if the detection timing does not arrive (No in S14), the control portion 7 shifts the process to step S15.

### Step S15

In step S15, the control portion 7 determines whether or not the specific period ends.

Specifically, in a case where the total time of the first time and the second time based on the conveyance speed of a sheet and the length of a sheet in the conveyance direction D6 elapses after the conveyance start timing of a sheet by the registration roller 55, the control portion 7 determines that the specific period ends.

Here, when the control portion 7 determines that the specific period ends (Yes in S15), the control portion 7 brings the operation control process to an end. In addition, if the specific period does not end (No in S15), the control portion 7 shifts the process to step S14.

Before the specific period ends, the image forming apparatus 100 adjusts the conveyance speed of a sheet by the fixing part 92 in this way on the basis of the amount of deflection of a sheet detected during the specific period. This makes it possible to control the amount of deflection of the sheet that is first conveyed after the image formation process starts.

It is noted that the number of times the first detection processing portion 63 detects the amount of deflection of a sheet in the specific period may be one.

In addition, before the specific period ends, the adjustment processing portion 64 may adjust the conveyance speed of a sheet by the transfer portion 91 on the basis of the amount of deflection of a sheet detected during the specific period.

In addition, before the specific period ends, the adjustment processing portion 64 may adjust the conveyance speed of a sheet by both the transfer portion 91 and the fixing part 92 on the basis of the amount of deflection of a sheet detected during the specific period.

In addition, the adjustment processing portion 64 may adjust the conveyance speed of a sheet by the fixing part 92 to bring the distance between a sheet and the guide surface 51A of the first guide member 51 into agreement with the specific distance based on the temperature and humidity of the installation place of the image forming apparatus 100. The temperature and humidity are detected by the temperature and humidity sensor 54. In this case, it is favorable that the storage portion 6 store in advance second table data indicating the relationship between the temperature and humidity of the installation place of the image forming apparatus 100 and the specific distance. It is favorable that the second table data define the relationship between the temperature and humidity of the installation place of the image forming apparatus 100 and the specific distance such that the specific distance in a case where it is determined that the installation place of the image forming apparatus 100 has high temperature and humidity (a sheet is difficult to charge) is the largest, and the specific distance in a case where it is determined that the installation place of the image forming apparatus 100 has low temperature and humidity (a sheet is easy to charge) is the smallest.

In addition, the adjustment processing portion 64 may adjust the conveyance speed of a sheet by the fixing part 92 to bring the distance between a sheet and the guide surface 51A of the first guide member 51 into agreement with the specific distance based on both the type of a sheet and the temperature and humidity of the installation place of the image forming apparatus 100. The temperature and humidity are detected by the temperature and humidity sensor 54. In this case, it is favorable that the storage portion 6 store in advance third table data indicating the relationship between a combination of the type of a sheet and the temperature and humidity of the installation place of the image forming apparatus 100 and the specific distance. It is favorable that the third table data define the relationship between a combination of the type of a sheet and the temperature and humidity of the installation place of the image forming apparatus 100 and the specific distance such that the specific distance in a case where a sheet is thick paper and it is high in temperature and humidity is the largest, and specific distance in a case where a sheet is thin paper and it is low in temperature and humidity is the smallest.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

An image forming apparatus including:

a transfer portion configured to transfer a toner image to a sheet and convey the sheet;

a fixing part configured to fix the toner image transferred to the sheet onto the sheet and convey the sheet, the fixing part being provided on a downstream side in a conveyance path of the sheet with respect to a conveyance direction of the sheet, the conveyance path extending through the transfer portion;

a first detection processing portion configured to detect an amount of deflection of the sheet during a specific period in which the sheet is conveyed by both the transfer portion and the fixing part; and

an adjustment processing portion configured to adjust, before the specific period ends, conveyance speed of the sheet by any one or both of the transfer portion and the fixing part on the basis of the amount of deflection detected during the specific period.

### Supplementary Note 2

The image forming apparatus according to Supplementary Note 1, in which

the first detection processing portion detects the amount of deflection in a detection cycle defined in advance, and

the adjustment processing portion adjusts the conveyance speed by any one or both of the transfer portion and the fixing part whenever the first detection processing portion detects the amount of deflection.

### Supplementary Note 3

The image forming apparatus according to Supplementary Note 1 or 2, including a guide member electrically grounded and configured to guide the sheet between the transfer portion and the fixing part in the conveyance path, the guide member having electrical conductivity, in which

the adjustment processing portion adjusts the conveyance speed by any one or both of the transfer portion and the fixing part to bring distance between the sheet and the guide member into agreement with specific distance based on any one or both of an attribute of the sheet and both of temperature and humidity of an installation place of the image forming apparatus.

### Supplementary Note 4

The image forming apparatus according to any of Supplementary Notes 1 to 3, including:

a distance sensor configured to be used to detect the amount of deflection; and

a second detection processing portion configured to detect, using the distance sensor, that an end of the sheet in the conveyance direction passes a detection position for the amount of deflection in the conveyance path.

### Supplementary Note 5

The image forming apparatus according to any of Supplementary Notes 1 to 4, in which the adjustment processing portion adjusts the conveyance speed by the fixing part.

### Supplementary Note 6

An operation control method that is executed by an image forming apparatus including a transfer portion and a fixing part, the transfer portion being configured to transfer a toner image to a sheet and convey the sheet, the fixing part being configured to fix the toner image transferred to the sheet onto the sheet and convey the sheet, the fixing part being provided on a downstream side in a conveyance path of the sheet with respect to a conveyance direction of the sheet, the conveyance path extending through the transfer portion, the operation control method including:

a detection step of detecting an amount of deflection of the sheet during a specific period in which the sheet is conveyed by both the transfer portion and the fixing part; and

an adjustment step of adjusting, before the specific period ends, conveyance speed of the sheet by any one or both of the transfer portion and the fixing part on the basis of the amount of deflection detected during the specific period.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a transfer portion configured to transfer a toner image to a sheet and convey the sheet;
a fixing part configured to fix the toner image transferred to the sheet onto the sheet and convey the sheet, the fixing part being provided on a downstream side in a conveyance path of the sheet with respect to a conveyance direction of the sheet, the conveyance path extending through the transfer portion;
a first detection processing portion configured to detect an amount of deflection of the sheet during a specific period in which the sheet is conveyed by both the transfer portion and the fixing part; and
an adjustment processing portion configured to adjust, before the specific period ends, conveyance speed of the sheet by any one or both of the transfer portion and the fixing part on a basis of the amount of deflection detected during the specific period.

2. The image forming apparatus according to claim 1, wherein
the first detection processing portion detects the amount of deflection in a detection cycle defined in advance, and
the adjustment processing portion adjusts the conveyance speed by any one or both of the transfer portion and the fixing part whenever the first detection processing portion detects the amount of deflection.

3. The image forming apparatus according to claim 1, comprising a guide member electrically grounded and configured to guide the sheet between the transfer portion and the fixing part in the conveyance path, the guide member having electrical conductivity, wherein
the adjustment processing portion adjusts the conveyance speed by any one or both of the transfer portion and the fixing part to bring distance between the sheet and the guide member into agreement with specific distance based on any one or both of an attribute of the sheet and both of temperature and humidity of an installation place of the image forming apparatus.

4. The image forming apparatus according to claim 1, comprising:
a distance sensor configured to be used to detect the amount of deflection; and
a second detection processing portion configured to detect, using the distance sensor, that an end of the sheet in the conveyance direction passes a detection position for the amount of deflection in the conveyance path.

5. The image forming apparatus according to claim 1, wherein the adjustment processing portion adjusts the conveyance speed by the fixing part.

6. An operation control method that is executed by an image forming apparatus including a transfer portion and a fixing part, the transfer portion being configured to transfer a toner image to a sheet and convey the sheet, the fixing part being configured to fix the toner image transferred to the sheet onto the sheet and convey the sheet, the fixing part being provided on a downstream side in a conveyance path of the sheet with respect to a conveyance direction of the sheet, the conveyance path extending through the transfer portion, the operation control method comprising:
a detection step of detecting an amount of deflection of the sheet during a specific period in which the sheet is conveyed by both the transfer portion and the fixing part; and
an adjustment step of adjusting, before the specific period ends, conveyance speed of the sheet by any one or both of the transfer portion and the fixing part on a basis of the amount of deflection detected during the specific period.
